(19) United States
(12) Patent Application Publication
(10) Pub. No.: US 2009/0001930 A1
(43) Pub. Date: Jan. 1, 2009

(54) Electronic apparatus and associated methods

(75) Inventor: Katri Helena Pohjonen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/824,571

(22) Filed: Jun. 29, 2007

(51) Int. Cl. H02J 7/00; H01Q 7/00

(52) U.S. Cl. 320/108; 343/866

(57) ABSTRACT

An apparatus for receiving electromagnetically induced current, the apparatus comprising an antenna element for receiving electromagnetically induced current in a first apparatus operating mode, and also for near field communication in a second apparatus operating mode, wherein the apparatus comprises circuitry for switching the apparatus from the second apparatus operating mode to the first apparatus operating mode based on near field communication signalling received via the antenna element in the second apparatus operating mode.

### TECHNICAL FIELD

The present invention relates to the field of charging of apparatus, particularly for portable electronic devices (e.g. modules for devices or the devices themselves), including but not limited to associated methods (including methods of operation and assembly of associated apparatus), and computer programs.

### BACKGROUND OF THE INVENTION

Portable electronic devices require a power supply to drive their electronic components. Such devices would often have an in-built rechargeable power supply (e.g. battery/batteries), which may or may not be removable from the device. Most commonly, such power supplies are recharged using a cable to connect the power supply to a recharging source (e.g. mains power supply, or another (e.g. car) battery).

For example, portable electronic devices, including communications devices (such as mobile phones and portable electronic message devices (including e-mail, Short Message Service (SMS) and Multimedia Message Service (MMS) devices), and music/video players (e.g. i-Pod™) are currently charged through a wire which connects the battery to a power source (e.g. mains or other possibly another battery e.g. in the case the device is being charged using the cigarette lighter port of a vehicle). In many such cases, there is time to charge the device battery during the night or while at work (i.e. stationary periods or when the device is not in high active use). However, charging via a wire may not always be convenient (e.g. requirement for the wire/plug or mains socket to be readily available).

However, there have been several proposals to introduce “contact-less” charging of battery/batteries based on various techniques (e.g. S. Y. R. Hui, W. C. Cho, A New Generation of Universal Contactless Battery Charging Platform for Portable Consumer Electronics Equipment, IEEE Transactions on Power Electronics, Vol. 20, No 3, May 2005, pp. 620 . . . 626; S. C. Tang et al., A Low-Profile Low-Power Converter with Coreless PCB Isolation Transformer, IEEE Transactions on Power Electronics 2001, Vol. 16, No. 3, Mar. 3, 2001, pp. 311 . . . 315; and B. Choi, et al, A New Contactless Battery Charger for Portable Telecommunication/Copuing Electronics, IEEE international Conference on Consumer Electronics 2001, pp. 58 . . . 59)

Inductive charging technique is a widely used technique used in electric toothbrushes etc. In order to achieve efficient (for example, greater than 50%) “contact-less” charging (and also a short charging time) low charging frequencies should be used (less than few hundred kHz). In such cases, magnetic cores are required for the inductively coupled coils both at the charger and at the device side. Special coil design techniques can be used to improve charging efficiency (e.g. Choi above). At high frequencies (greater than some hundred kilohertz) inductive contact-less charging with cheap coreless, planar coils manufactured on a printed wiring board (PWB) have been demonstrated successfully.

As will be appreciated, radio-frequency induction or RF induction is the use of a radio frequency magnetic field to transfer energy by means of electromagnetic induction in the near field. A radio-frequency alternating current is passed through a coil of wire that acts as the transmitter, and a second coil or conducting object, magnetically coupled to the first coil, acts as the receiver. In principle, electromagnetic induction produces a voltage across the second coil situated in a changing magnetic field or in the second coil moving through a stationary magnetic field.

Other documents, which may or may not be relevant to the present claimed invention, may include:

U.S. Pat. No. 6,184,651 which describes a contactless charging system comprising an inductive coupler for transferring charging energy; and a wireless RF receiver;

U.S. Pat. No. 6,208,115 which describes a battery and an energy transfer circuit capable of receiving electrical energy remotely via a contactless charging unit and at least partially energizing the electrical appliance.

U.S. Pat. No. 7,042,196 which describes a portable electrical or electronic device adapted to receive power inductively from a primary unit. FIG. 2a shows a prior art inductive systems typically used in powering radio frequency passive tags.

U.S. Pat. No. 6,275,681 which describes a wireless electrostatic rechargeable device which uses the principle of electrostatic induction (a method by which an electrically charged object can be used to create an electrical charge in a second object, without contact between the two objects). In one embodiment, the document describes an electrostatic system for charging or communicating with an electrostatic rechargeable device or transceiver such as a smart card or radio frequency identification (RFID) card without requiring physical contact to electrodes. FIG. 7 illustrates a second embodiment in which an electrostatic and electromagnetic charging system 700 can simultaneously charge the energy storage means and communicate information by means of inductive coupling or capacitive coupling.

Radio-frequency identification (RFID) is an automatic identification method, relying on storing and remotely retrieving data using devices called RFID tags or transponders. An RFID tag is an object that can be attached to or incorporated into a product, animal, or person for the purpose of identification using radio waves. All RFID tags contain at least two parts. One is an integrated circuit for storing and processing information, modulating and demodulating a radio frequency (RF) signal, and perhaps other specialized functions. The second is an antenna element for receiving and transmitting the signal.

The RFID tag can automatically be read from several meters away and does not have to be in the line of sight of the reader. RFID tags come in three general varieties: passive, semi-passive (also known as battery-assisted), or active. Passive tags require no internal power source, whereas semi-passive and active tags require a power source, usually a small battery.

As mentioned above, passive RFID tags have no internal power supply. The minute electrical current induced in the antenna by the incoming radio frequency signal provides just enough power for the CMOS integrated circuit in the tag to power up and transmit a response. Most passive tags signal by backscattering the carrier wave from the reader. This means that the tag antenna element has to be designed to both collect power from the incoming signal, and also to transmit the outbound backscatter signal. The response of a passive RFID tag is not necessarily just an ID number; the tag chip can contain non-volatile EEPROM for storing data.

Passive tags currently have practical read distances ranging from about 10 cm (ISO 14443), or up to a few meters (Electronic Product Code (EPC) and ISO 18000-6), depending on the chosen radio frequency and antenna design/size. Due to their simplicity in design they are also suitable for manufacture with a printing process for the antennas. The lack of an onboard power supply means that the device can be quite small: commercially available products exist that can be embedded in a sticker, or under the skin in the case of low frequency RFID tags.

Unlike passive RFID tags, active RFID tags have their own internal power source, which is used to power the integrated circuits, and broadcast the signal to the reader. Active tags are typically much more reliable (e.g. fewer errors) than passive tags due to the ability for active tags to conduct a “session” with a reader. Active tags, due to their onboard power supply, also transmit at higher power levels than passive tags, allowing them to be more effective in “RF challenged” environments like water (including humans/cattle, which are mostly water), metal (shipping containers, vehicles), or at longer distances. Many active tags have practical ranges of hundreds of meters, and a battery life of up to 10 years. Active tags typically have much longer range (approximately 100 m/300 feet) and larger memories than passive tags, as well as the ability to store additional information sent by the transceiver.

Semi-passive tags are similar to active tags as they have their own power source, but the battery is used just to power the microchip and not broadcast a signal. The RF energy is reflected back to the reader like a passive tag.

The antenna used for an RFID tag is affected by the intended application and the frequency of operation. Low-frequency (LF) passive tags are normally inductively coupled, and because the voltage induced is proportional to frequency, many coil turns are needed to produce enough voltage to operate an integrated circuit. Compact LF tags, like glass-encapsulated tags used in animal and human identification, use a multilayer coil (3 layers of 100-150 turns each) wrapped around a ferrite core.

At 13.56 MHz (High frequency or HF), a planar spiral with 5-7 turns over a credit-card-sized form factor can be used to provide ranges of tens of centimetres. These coils are less costly to produce than LF coils, since they can be made using lithographic techniques rather than by wire winding, but two metal layers and an insulator layer are needed to allow for the crossover connection from the outermost layer to the inside of the spiral where the integrated circuit and resonance capacitor are located.

Ultra-high frequency (UHF) and microwave passive tags are usually radiatively-coupled to the reader antenna and can employ conventional dipole-like antennas. Only one metal layer is required, reducing cost of manufacturing. Dipole antennas, however, are a poor match to the high and slightly capacitive input impedance of a typical integrated circuit. Folded dipoles, or short loops acting as inductive matching structures, are often employed to improve power delivery to the IC. Half-wave dipoles (16 cm at 900 mHz) are too big for many applications; for example, tags embedded in labels must be less than 100 mm (4 inches) in extent. To reduce the length of the antenna, antennas can be bent or meandered, and capacitive tip-loading or bowtie-like broadband structures are also used. Compact antennas usually have gain less than that of a dipole, that is, less than 2 dBi, and can be regarded as isotropic in the plane perpendicular to their axis.

Dipoles couple to radiation polarized along their axes, so the visibility of a tag with a simple dipole-like antenna is orientation-dependent. Tags with two orthogonal or nearly-orthogonal antennas, often known as dual-dipole tags, are much less dependent on orientation and polarization of the reader antenna, but are larger and more expensive than single-dipole tags.

Patch antennas are used to provide service in close proximity to metal surfaces, but a structure with good bandwidth is 3-6 mm thick, and the need to provide a ground layer and ground connection increases cost relative to simpler single-layer structures.

HF and UHF tag antennas are usually fabricated from copper or aluminium. Conductive inks have seen some use in tag antennas.

It will be appreciated that physically, an antenna is an arrangement of conductive material that is used to generate a radiating electromagnetic field in response to an applied alternating voltage and the associated alternating electric current, or can be placed in an electromagnetic field so that the field will induce an alternating current in the antenna and a voltage between its terminals.

The “resonant frequency” and “electrical resonance” is related to the electrical length of the antenna. The electrical length is usually the physical length of the wire divided by its velocity factor (the ratio of the speed of wave propagation in the wire to c₀, the speed of light in a vacuum). Typically an antenna is tuned for a specific frequency, and is effective for a range of frequencies usually centered on that resonant frequency. However, the other properties of the antenna (especially radiation pattern and impedance) change with frequency, so the antenna's resonant frequency may merely be close to the center frequency of these other more important properties.

Antennas can be made resonant on harmonic frequencies with lengths that are fractions of the target wavelength. Some antenna designs have multiple resonant frequencies, and some are relatively effective over a very broad range of frequencies. The most commonly known type of wide band aerial is the logarithmic or log periodic, but its gain is usually much lower than that of a specific or narrower band aerial.

The “bandwidth” of an antenna is the range of frequencies over which it is effective, usually centered around the resonant frequency. The bandwidth of an antenna may be increased by several techniques, including using thicker wires, replacing wires with cages to simulate a thicker wire, tapering antenna components (like in a feed horn), and combining multiple antennas into a single assembly and allowing the natural impedance to select the correct antenna. Small antennas are usually preferred for convenience, but there is a fundamental limit relating bandwidth, size and efficiency.

RFID can be considered to be a Near Field Communication (NFC) technology, which is operative wirelessly over a short-range (“hands width”), which in current mobile phones has a usage range of 0-20 cm.

The listing or discussion of a prior-published document in this specification should not necessarily be taken as an acknowledgement that the document is part of the state of the art or is common general knowledge. One or more embodiments of the present invention may use one or more of the components described in the background section.

### SUMMARY OF THE INVENTION

In a first aspect, there is provided an apparatus for receiving electromagnetically induced current, the apparatus comprising an antenna element for receiving electromagnetically induced current in a first apparatus operating mode, and also for near field communication, in a second apparatus operating mode, wherein the apparatus comprises circuitry for switching the apparatus from the second apparatus operating mode to the first apparatus operating mode based on near field communication signalling received via the antenna element in the second apparatus operating mode.

In this way, the same antenna element is used for the two apparatus operating modes; receiving electromagnetically induced current and also for near field communication (NFC). It will be appreciated that the apparatus may have other operating modes in addition to the modes mentioned. The switching circuitry is provided to switch between the two operating modes. The switching circuitry operates by receiving near field switch signalling when the antenna element is configured for receiving near field communications.

The apparatus may be configured to provide near field communication signalling using the antenna element (in the second apparatus operating mode) to an associated apparatus for providing electromagnetically induced current to move the associated apparatus for providing electromagnetically induced current to a powered down state.

This powered down state would be a state of the associated apparatus which draws less power than a powered up state. In one such powered up state, the associated apparatus may be arranged to generate a radiating electromagnetic field for the provision of induced current.

The apparatus may be arranged to receive near field communication signalling from an associated apparatus for electromagnetically inducing current, the signalling providing details of the charging characteristics for the current inducing apparatus, and wherein the apparatus is configured to use the signalling to allow the apparatus to determine whether the apparatus for electromagnetically inducing current can be used to provide induced current to the apparatus.

Associated computer programs for controlling the switching circuitry are also provided. For example, a computer program comprising computer code arranged to control the switching of an antenna element between use in a first mode for receiving electromagnetic induced current and a second mode for use in near field communication based on near field communication signalling received via the antenna element.

In a second aspect, there is provided an apparatus for receiving electromagnetically induced current, the apparatus comprising an antenna element having a length to allow the antenna element to be used to receive electromagnetically induced current via the antenna element from associated electromagnetic induction circuitry, and wherein the apparatus is arranged such that a portion of the antenna element's length can also be used for near field communication with an associated apparatus for near field communication.

This apparatus provides that part of an antenna element for electromagnetic induction can also be used for near field communication. Near field communication (i.e. circuitry for near field communication) may be for providing data signalling to an associated apparatus using the antenna element, and/or near field communication may be for receiving data signalling from an associated apparatus using the antenna element.

The apparatus for receiving induced current may comprise a power source used to store and provide power to one or more of the electronic components of the apparatus, and wherein the apparatus may be arranged to provide electromagnetically induced current for storage in the power source in a first apparatus operating mode. One example of such a power source is a rechargeable battery which is removable from the apparatus.

Associated computer program products to control the use of the antenna element are also provided. For example, the computer program product may comprise computer code stored in a memory to control the use of an antenna element such that it has a length to allow the antenna element to be used to receive electromagnetically induced current, and such that a portion of the antenna element length can be used for near field communication.

In a third aspect, there is provided an apparatus for generating a radiating electromagnetic field to be used to induce current in an associated apparatus, the apparatus comprising a first antenna element to radiate said electromagnetic field for electromagnetic induction, and a second antenna element for near field communication to provide near field communication signalling to indicate that said apparatus can provide current by electromagnetic induction.

In this way, the apparatus for generating a radiating electromagnetic field (i.e. for providing induced current (e.g. a charging device)) can be used to indicate to a nearby apparatus (with near field communication capability) that it is possible to use the current inducing apparatus (or that the current inducing apparatus is available for use) to charge the nearby apparatus. The signalling from the current inducing apparatus may provide details of the charging characteristics for the current inducing apparatus to allow the nearby apparatus to determine whether the current inducing apparatus can be used (is compatible for use) to charge the nearby apparatus.

Associated computer program products are also provided. For example, a computer program product for an apparatus for generating an electromagnetic field, the computer program product comprising computer code stored in a memory to use near field communication circuitry to indicate that apparatus can be used for inducing a current.

In a fourth aspect, there is provided an apparatus for receiving electromagnetically induced current, the apparatus comprising an antenna element with a first portion having a first length to allow the antenna element to be used in near field communication with an associated apparatus for near field communication, and a second portion having a second length, wherein the apparatus is arranged such that the first and second portions of the antenna element can be used together to provide an antenna element having a combined length which can be used to receive electromagnetically induced current from associated electromagnetic induction circuitry.

This apparatus provides that an antenna element has a length for near field communication. This antenna element, in combination with another antenna element having its own antenna length, provide a combined antenna length for the apparatus which can be used to receive electromagnetic induced current. The apparatus is arranged such the differing antenna lengths can be used to provide the differing functions.

Associated computer program products are also provided. For example, a computer program product for controlling the use of antenna elements having respective first and second lengths, the computer program product comprising computer code stored in a memory to use an antenna with the first length for near field communication, and to use the first and second antenna elements in combination to receive electromagnetically induced current.

Corresponding antenna elements are also provided. For example, in a fifth aspect, there is provided an antenna element, the antenna element having a length to allow the antenna element to be used to receive electromagnetically induced current via the antenna element from associated electromagnetic induction circuitry, and wherein the antenna element is arranged such that a portion of its length can also be used for near field communication with an associated apparatus for near field communication.

In a sixth aspect, there is provided an antenna element, the antenna element comprising a first portion having a first length to allow the antenna element to be used in near field communication with an associated apparatus for near field communication, and a second portion having a second length, wherein the antenna element is arranged such that the first and second portions of the antenna element can be used together to provide an antenna element having a combined length which can be used to receive electromagnetically induced current from associated electromagnetic induction circuitry. It will be appreciated that the “associated apparatus for near field communication” need not actually be associated with the antenna element, but that the antenna element has a first length which “allows” it “to be used in near field communication” when an appropriate apparatus for near field communication is associated with it.

The antenna element lengths may be the electrical length of the antenna elements. The antenna element length may be the physical length of the antenna.

The antenna element, and/or antenna element portions may have lengths such that, when used for near field communication, the antenna element (and/or element portions) have a resonant frequency of the order of 10 MHz, and when used to receive induced current, they have a resonant frequency of the order of 1 MHz or less.

The antenna element, and/or the antenna element portions may be comprised from one or more of coiled conductors, a planar (e.g. coil) conductor, a Printed Wiring Board with its embedded copper arranged as an antenna, a conductor on an insulating carrier film, a printed conductive material on a carrier film (e.g. attached to a product cover), and a conductive material placed on a device (internal/external) cover.

The antenna element portions may be arranged to be in the same plane as one another (e.g. side to side) or may be in different planes with respect to one another (e.g. one above another).

The near field communication circuitry may be so-called active, passive or semi-active near field communications circuitry for RFID.

One or more of the apparatuses may be part of a portable electronic device, suitable for carrying by a human, and for example including a mobile communication (e.g. email/SMS/MMS messaging device) device or smart mobile phone, a personal digital assistant unit or laptop/tablet PC, a personal music player or mp3 player or digital/analogue radio, a games or other entertainment unit, a navigation device for example a satellite navigation unit, or a data storage unit.

The present invention includes one or more aspects, embodiments or features in isolation or in various combinations whether or not specifically stated (including claimed) in that combination or in isolation. Associated methods of assembly os the apparatus are also within the present disclosure. Corresponding means for performing one or more of the functions disclosed are also with the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1 presents a simplified architecture of the contact-less charging by using RFID coil of the product/device to be charged as part of the contact-less charging;

FIG. 2 presents the product/product of FIG. 1 in a normal operating mode (i.e. not charging via contact-less charging, and RFID transceiver able to read and/or write via the planar coil);

FIG. 3a presents the contact-less charging triggered/started by reading an RFID label/TAG of a charging platform, step1 placing the product near (within reading distance of the NFC RFID of the product) to the charging platform/plate;

FIG. 3b presents a product in the charging operating mode after detection of ‘charge’ or equivalent command signalling from the RFID TAG of the charging platform/plate; and

FIG. 4 shows antenna elements for use in one or more embodiments.

### DETAILED DESCRIPTION

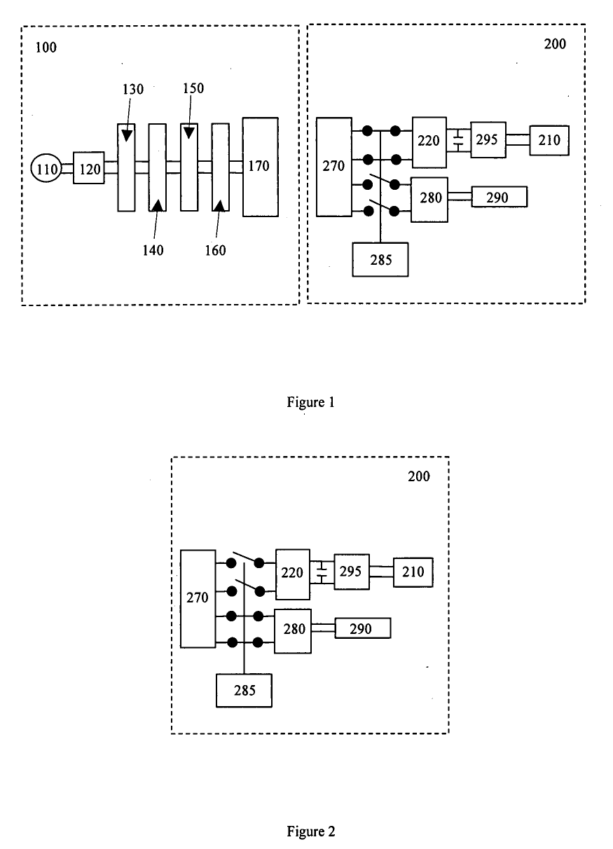

FIG. 1 shows a charging platform/plate 100 which acts as an apparatus for generating a radiating electromagnetic field to be used to induce current in a device 200 which is associated (e.g. in near proximity) with the plate 100. In this case, the platform 100 is shaped to allow a device 200, which is to be charged, to be conveniently placed on top of the platform 100 to allow charging. It will be appreciated that although the apparatus 100 in this embodiment is a platform, in other embodiments it may have a different structure so long as it provides contactless charging (i.e. does not require the insertion of a plug into the device 200 to provide charging of the device 200). Therefore, in other embodiments, physical contact between the plate 100 and the device 200 may not be required to perform charging i.e. charging may occur if the device 200 is in close proximity (within the region of near field communication) to the plate 100.

In this case, the plate 100 comprises an alternating current source 110, the output of which is connected to the input of a rectifier 120. The output of the rectifier 120 is connected to capacitors 130 which in turn are connected in series to switching circuitry 140, transformer circuitry 150 and filtering circuitry 150. The output of the filtering circuitry 150 is provided to a planar coil antenna element 170. The alternating current is used to provide a changing magnetic field to the antenna element 170, and this changing magnetic field is used to induce a current in an associated antenna element 270 of the device 200 to be charged. When in operation, the two antenna elements 170, 270 can be considered to be a coreless transformer.

A portable electronic apparatus for receiving electromagnetically induced current is shown in FIGS. 1 and 2 in respective two different modes of operation. In this case, the apparatus is a mobile phone 200 comprising a rechargeable power source (e.g. battery or battery stack) 210 which ordinarily provides power to the phone 200. The phone 200 is configured to have circuitry for charging 220, 295 the power source 210, and circuitry for near field communication (in this case RFID communication) 280, 290 both configured for use with a common antenna element 270, and switching circuitry 285 to switch the respective circuitries to use the common antenna element 270 and thus provide the two operating modes; charging and RFID communication.

In the charging mode (FIG. 1), the circuitry for charging 220, 295 is connected to the common antenna element 270 (which in this can is a planar coil). This circuitry 220, 295 comprises a rectifier and matching circuitry 220 which is connected to the output of the antenna element 270. The circuitry 220 is in turn connected to capacitors and charging electronics with control circuitry 295 which in turn is connected to the rechargeable power source 210. The charging electronics 295 of the power source 210 should be near to the coil 270 to minimise losses during charging.

In the RFID mode (FIG. 2), which may provide reading and/or transmitting functions to an associated apparatus e.g. read data from an associated RFID tag, or transmit data to an associated RFID tag or RFID reader. The circuitry for near field communication 280, 290 is connected to the common antenna element 270. The circuitry comprises matching circuitry 280 arranged to be connectable to the common antenna element 270, to which is connected RFID transceiver circuitry 290 for performing read and/or writing functions.

The switching circuitry 285 may be actuated by a mechanical button, and/or from a menu provided on the user interface of the mobile phone 200. The actuation of the charging mode could be combined with the power-on/-off button, so that a long push means shut-down and short-push means ‘start charging’. This manual charging option could conveniently be selected before laying the product on the charging plate/platform 100, or when the product is on the charging plate/platform 100.

The switching elements should be carefully chosen to maximise the value of Q of the antenna element 270 when being used in near field communication. This would, for example, maximise the effective distance over which the phone 200 can be used for near field communication.

In the present case, the plate 100 and phone 200 are configured such that charging and near field communication occur when the separation is of the order of 10 cm or less. However, in other embodiment, the separation may be different but still within the context of near field communication.

The planar coil antenna element 270 may be on the same PWB as all the other phone electronics, or share a PWB with some or all of the phone electronics, or be on a separate PWB and/or flexible circuit board embedded inside a phone cover. The antenna element 270 may be located over one face of the phone cover or extend over multiple phone cover faces.

In one embodiment, the planar coil antenna element 270 is a single antenna element having a particular charging length usable in the charging mode of the phone. The antenna element 270 also has a shorter near field communication length, which is usable in the near field communication mode. Thus, in the near field communication mode, the shorter antenna length is used, and in charging mode, the larger charging length is used. The larger charging length may be the full length of the antenna element, or still a partial length of the antenna element.

In another embodiment (FIG. 4), the antenna element 270 comprises two antenna elements 270A, 270B which are used together in the charging mode to provide a combined length which can be used in charging. However, in the RFID mode, one or other of the antenna elements 270A, 270B are useable. According to the embodiment, the combined length may not necessarily be the full combined length of the respective antenna elements 270A, 270B. Use may be made of antenna elements (e.g. 270A, 270B) arranged in series/parallel which are electrically connectable/disconnectable to one another to provide the required antenna length for the particular operating mode. These antenna elements may be planar coils.

In one embodiment, the phone 200 is configured such that the frequency used for current NFC communication is 13.56 MHz, with a maximum reading distance of 10-70 mm to/from the antenna element 270, with coils with values of 1-4 micro Henries (μH) and Q (quality factor) values of 10-30 at 13.56 MHz. These coils can be manufactured on PWB which can be either attached on the product cover or embedded inside the product cover. The area needed for this kind of a coil can be for example oval or round and approximately 1.5-7.0 cm by diameter or by largest distance when manufactured on 1 or 2 layer PWB. The electrical performance described is achievable with a typical 100 μm wide and 15-100 μm thick copper trace on a PWB. The antenna element 270 can be coreless open planar copper windings on PWB, flexible material or a combination of both.

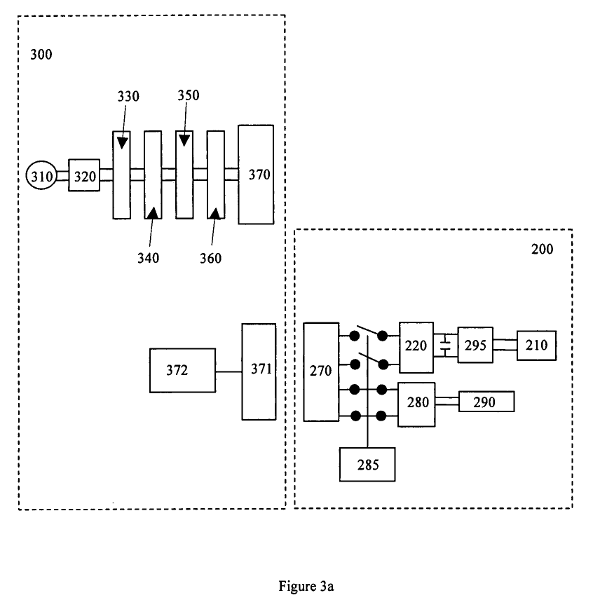

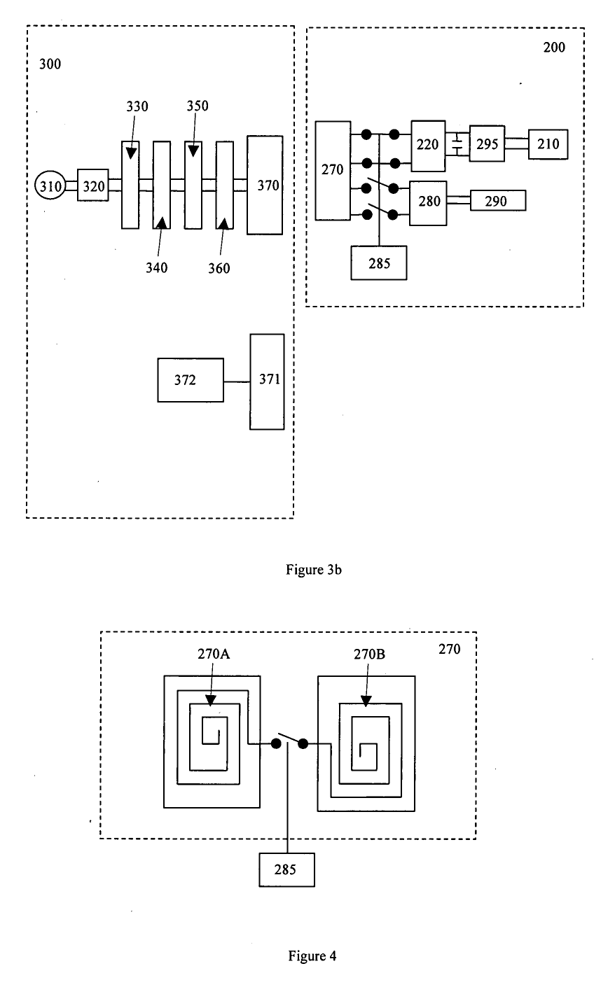

The embodiments of FIG. 3 show triggering of the charging mode of the phone 200 using an RFID tag 371, 372 in a charging plate 300. Corresponding reference numerals to the plate 200 have been given to the individual circuitry elements of plate 300 (e.g. 370 is the antenna coil). In this case, the plate 300 comprises a RFID tag antenna element 371 and corresponding RFID circuitry 372. The RFID tag 371, 372 is configured such that it provides a “charge” signal to a device which is in near field communication with it. Thus, when the phone 200 is close enough to the antenna element 371, the antenna element 270 receives the “charge” data signal. This is processed by the circuitry 285 to move the phone 200 from the RFID mode (FIG. 3a) to the charging mode (FIG. 3b).

In some embodiments, the RFID tag 371, 372 may also provide signalling with the charging characteristics of the plate 300 to allow the phone 200 to determine whether it is able to use the plate 300 for charging. This allow the phone 200 to determine whether the plate 300 is compatible for use, or allow the phone to change its configuration from a non-compatible or non-optimal configuration into respective compatible or optimal configurations.

The phone 200 may be configured such that it does not automatically act to the “charge” command signalling to mode the phone into the charging mode. This may be because the power source 210 is already full. If it is detected that the power source 210 is full (i.e. charging not required) the phone 200 may be moved back into the near field communication mode.

In one embodiment, the apparatus 300 may be configured such that the antenna elements 370 and 371 are part of the same single antenna element, or can be used together in combination to provide a combined antenna length for near field communication (as with the mobile phone 200).

In certain embodiments, the circuitry 290 may be used to signal to the apparatus 300 using the near field communication circuitry to move the apparatus 300 to a powered down state. In this case, the apparatus 300 can be conveniently moved to a powered down state when the power source 210 in the phone 200 is detected (by the phone 200, plate 300) to be full. Such embodiment may become increasingly significant when quiescent power becomes more important.

In general, an antenna or aerial is a transducer designed to transmit or receive radio waves which are a class of electromagnetic waves. In other words, antennas convert radio frequency electrical currents into electromagnetic waves and vice versa. Antennas are used in systems such as radio and television broadcasting, point-to-point radio communication, wireless LAN, radar, and space exploration. Antennas usually work in air or outer space, but can also be operated under water or even through soil and rock at certain frequencies for short distances. Electrical lengthening is the modification of an aerial which is shorter than a whole-number multiple of a quarter of the radiated wavelength, by means of a suitable electronic device, without changing the physical length of the aerial, in such a way that it corresponds electrically to the next whole-number multiple of a quarter of the used wavelength. A lengthening is only possible to the next whole-number multiple of a quarter of the radiated wavelength. Thus an aerial with a length corresponding to the eighth of the radiated wavelength can be extended only to a quarter wave radiator, but not to a half wave radiator.

One understands by electric shortening the modification of an aerial which is longer than the whole-number multiple of the quarter of the radiated wavelength, by suitable electronic device without changing the length of the aerial in such a way that it corresponds electrically to the previous whole-number multiples of the quarter of the used wavelength. Basically a shortening is only possible to the last whole-number multiples of the quarter of the radiated wavelength. Thus an aerial with a length corresponding to five-eighths of the radiated wavelength can be shortened, only to a half wave radiator, but not to a quarter wave radiator.

One or more embodiments may use electrical lengthening and/or shorting techniques to implement the use of the same antenna element in charging and near field communication modes.

In general, one or more embodiments advantageously provide that:
the large area coil needed for RFID functionality is also used for inductive charging of the product in contact-less charging without significantly adding to the product cost or size
the coil can be low cost planar PWB coil or planar coil on a flexible circuit board or any combination of those
without certain embodiments, the space and additional cost required for contact-less charging can prevent the wide use of contact-less charging.
additional thickness can be avoided by embedding the RFID coil inside the product cover
modest increase in weight of the products because the only additional parts are the switches (and logic needed to drive them) which decouple or couple the RFID coil from/to RFID reading&writing electronics in the product
if charging is happening/starting without any extra effort of the end user, the end user may feel extension of battery capacity i.e. the battery is easily maintained at a full.

It will be appreciated that the aforementioned circuitry may have other functions in addition to the mentioned functions, and that these functions may be performed by the same circuit.

For example, as inductive charging typically takes place at much lower frequencies (e.g. like 100 kHz-1.5 MHz, which depends on the switching frequency in the plate 100) compared to 13.56 MHz of RFID (reserved in NFC standard), there might be the need to use an additional antenna element coil connected series with the RFID coil on the product side.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. An apparatus for receiving electromagnetically induced current, comprising an antenna element for receiving electromagnetically induced current in a first apparatus operating mode, and also for near field communication in a second apparatus operating mode, and circuitry for switching the apparatus from the second apparatus operating mode to the first apparatus operating mode based on near field communication signalling received via the antenna element in the second apparatus operating mode.

2. The apparatus according to claim 1, wherein the second apparatus operating mode provides for radio frequency identification communication.

3. The apparatus according to claim 1, wherein the apparatus is configured to provide near field communication signalling using the antenna element to an associated apparatus for providing electromagnetically induced current to move the associated apparatus for providing electromagnetically induced current to a powered down state.

4. The apparatus according to claim 1, wherein the apparatus is arranged to receive near field communication signalling from an associated apparatus for electromagnetically inducing current, the signalling providing details of the charging characteristics for the current inducing apparatus, and wherein the apparatus is configured to use the signalling to allow the apparatus to determine whether the apparatus for electromagnetically inducing current can be used to provide induced current to the apparatus.

5. The apparatus according to claim 1, wherein the apparatus is arranged such that the near field communication provides data signalling to an associated apparatus using the antenna element.

6. The apparatus according to claim 1, wherein the apparatus is arranged such that the near field communication provides for receiving data signalling from an associated apparatus using the antenna element.

7. The apparatus according to claim 1, wherein the antenna element has a length in the second apparatus operating mode for near field communication and shorter length for receiving magnetically induced current in the first apparatus operating mode.

8. The apparatus according to claim 1, wherein the antenna element is arranged to have a resonant frequency of the order of 10 MHz when used in the second apparatus operating mode, and of 1 MHz or less when used to receive induced current in the first apparatus operating mode.

9. The apparatus according to claim 1, wherein the antenna element is comprised as one or more of conductors selected from the group comprising coiled conductors, a planar coil conductor, a printed wiring board with its embedded copper arranged as an antenna, a conductor on an insulating carrier film, a printed conductive material on a carrier film, and a conductive material placed on a device cover.

10. A computer program product for controlling switching circuitry, comprising computer code stored in a memory and for execution, such that when executed, the code is arranged to control the switching of an antenna element between use in a first mode for receiving electromagnetically induced current and a second mode for use in near field communication based on near field signalling received via the antenna element.

11. An apparatus for receiving electromagnetically induced current, the apparatus comprising a receiver for receiving electromagnetically induced current in a first mode and also for near field communication in a second mode, wherein the apparatus comprises a switch for switching the apparatus from the second mode to the first mode based on near field communication signalling received via the means in the second mode.

12. An apparatus for receiving electromagnetically induced current, comprising: an antenna element having a length to allow the antenna element to be used to receive electromagnetically induced current via the antenna element from associated electromagnetic induction circuitry, and wherein the apparatus is arranged such that a portion of the antenna element's length can also be used for near field communication with an associated apparatus for near field communication.

13. The apparatus according to claim 12, wherein the apparatus comprises a power source used to store and provide power to one or more of the electronic components of the apparatus, and wherein the apparatus is arranged to provide electromagnetically induced current for storage in the power source in first apparatus operating mode.

14. An apparatus for receiving electromagnetically induced current, the apparatus comprising a receiver for receiving electromagnetically induced current having a length to allow the receiver to be used to receive electromagnetically induced current via the means from associated means for providing electromagnetic induction to induce current, and wherein the apparatus is arranged such that a portion of the means's length can also be used for near field communication with an associated apparatus for near field communication.

15. A computer program product comprising computer code stored in a memory and for execution, such that when executed, the code is arranged to control the use of an antenna element such that it has a length to allow the antenna element to be used to receive electromagnetically induced current, and such that a portion of the antenna element length can be used for near field communication.

16. An apparatus for generating a radiating electromagnetic field to be used to induce current in an associated apparatus comprising: a first antenna element to radiate said electromagnetic field for electromagnetic induction, and a second antenna element for near field communication to provide near field communication signalling to indicate that said apparatus can provide current by electromagnetic induction.

17. The apparatus according to claim 16, wherein the apparatus is arranged to receive near field communication signalling from an associated apparatus for receiving induced current to move the apparatus for generating a radiating electromagnetic field to a powered down state.

18. An apparatus for generating a radiating electromagnetic field to be used to induce current in an associated apparatus, the apparatus comprising a first antenna element for radiating said electromagnetic field for electromagnetic induction, and a second antenna element for near field communication to provide near field communication signalling to indicate that said apparatus can provide current by electromagnetic induction.

19. A computer program product for an apparatus for generating an electromagnetic field, the computer program product comprising computer code stored in a memory and for execution, such that when executed, the code is arranged to use near field communication circuitry to indicate that the apparatus can be used for inducing a current.

20. An apparatus for receiving electromagnetically induced current comprising: an antenna element with a first portion having a first length to allow the antenna element to be used in near field communication with an associated apparatus for near field communication, and a second portion having a second length, wherein the apparatus is arranged such that the first and second portions of the antenna element can be used together to provide an antenna element having a combined length which can be used to receive electromagnetically induced current from associated electromagnetic induction circuitry.

21. A computer program product for controlling the use of antenna elements having respective first and second lengths, the computer program product comprising computer code stored in a memory and for execution, such that when executed, the code is arranged to use an antenna with the first length for near field communication, and to use the first and second antenna elements in combination to receive electromagnetically induced current.

22. An antenna element, the antenna element having a length to allow the antenna element to be used to receive electromagnetically induced current via the antenna element from associated electromagnetic induction circuitry, and wherein the antenna element is arranged such that a portion of its length can also be used for near field communication with an associated apparatus for near field communication.

23. The antenna element according to claim 22, wherein the lengths are physical lengths of the antenna elements.

24. The antenna element according to claim 22, wherein the lengths are electrical lengths of the antenna elements.

25. An antenna element, the antenna element comprising a first portion having a first length to allow the antenna element to be used in near field communication with an associated apparatus for near field communication, and a second portion having a second length, wherein the antenna element is arranged such that the first and second portions of the antenna element can be used together to provide an antenna element having a combined length which can be used to receive electromagnetically induced current from associated electromagnetic induction circuitry.

26. The antenna element according to claim 25, wherein the lengths are physical lengths of the antenna elements.

27. The antenna element according to claim 25, wherein the lengths are electrical lengths of the antenna elements.

28. An apparatus for receiving electromagnetically induced current comprising: a first portion having a first length to allow the apparatus to be used in near field communication with an associated apparatus for near field communication, and a second portion having a second length, wherein the apparatus is arranged such that the first and second portions can be used together to provide a combined length which can be used to receive electromagnetically induced current from associated apparatus for generating an electromagnetic field for inducing current.
